(19) United States
(12) Patent Application Publication
(10) Pub. No.: US 2003/0227272 A1
(43) Pub. Date: Dec. 11, 2003

(54) Motor monitoring system

(76) Inventors: Chia-Chang Hsu, Hsinchu (TW); Chung-Hsien Lin, Banchiau City (TW)

Correspondence Address: RABIN & CHAMPAGNE, PC, 1101 14TH STREET, NW, SUITE 500, WASHINGTON, DC, 20005, US

(21) Appl. No.: 10/454,618

(22) Filed: Jun. 5, 2003

(30) Foreign Application Priority Data
Jun. 6, 2002 (TW) 091112259

(51) Int. Cl. H02P 1/04; G08B 21/00

(52) U.S. Cl. 318/471; 340/679; 340/584

(57) ABSTRACT

A motor monitoring system including a control chip and a motor is disclosed. The control chip could be a chipset or a monitoring chip able to control the rotational speed of the motor. The control chip is used to receive a temperature reading and output a control signal according to the temperature reading. The motor receives the control signal and automatically adjusts the speed of its own accordingly. Hence, the configuration of the monitoring system is simplified, the R&D flow is shortened, and the cost of R&D and manufacturing are greatly reduced.

This application claims the benefit of Taiwan application Serial No. 091112259, filed Jun. 6, 2002.

### BACKGROUND OF THE INVENTION

1. Field of the Invention

The invention relates in general to a motor monitoring system, and more particularly to a motor monitoring system designed to monitor and adjust a motor's rotational speed according to the ambient temperature.

2. Description of the Related Art

Please refer to FIG. 1, a diagram illustrating a conventional motor monitoring system 100. The motor 150 could be an electric fan. The motor monitoring system 100 can be equipped in a notebook computer. A notebook computer with the motor monitoring system has the function of auto-temperature adjustment by controlling the rotational speed of the electric fan according to the ambient temperature. To meet the requirements of various rotational speeds under different temperature, the motor used herein needs to has the function of rotational speed setting. The conventional motor monitoring system 100 includes a chipset 110 in a computer, a monitoring unit 120, a digital to analog converter D/A 130, a charge pump 140 and a motor 150. According to the inputted temperature reading of the interior of the notebook computer, the chipset 110 outputs a signal for controlling the rotational speed of the fan to the monitoring unit 120. The monitoring unit 120 then outputs a control signal. The control signal is then transformed to an analog signal by the D/A 130 and inputted to the charge pump 140. The charge pump 140 controls the rotational speed of the motor 150 according to the analog signal. The motor 150 has the function of outputting the rotational frequency f, which is fed back to the monitoring unit 120. In accordance with the rotational frequency f, the monitoring unit 120 can modify the outputting control signal. To optimize the speed of the motor 100, the conventional monitoring system 100 must include complex voltage regulators like the D/A and charge pump mentioned above, which directly influence the cost of the whole motor monitoring system.

### SUMMARY OF THE INVENTION

It is therefore an object of the invention to provide a monitoring system of motor that has a simple and easy framework.

The invention achieves the above-identified objects by providing a monitoring system of motor that includes a control chip and a motor. The control chip is used to receive a temperature reading and output a control signal according to the temperature reading. The motor is used to receive the control signal and automatically adjust the speed of its own according to the control signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram illustrating a conventional motor monitoring system;

FIG. 2 is a diagram illustrating a motor monitoring system according to the first embodiment of the invention;

FIG. 3 is a diagram illustrating a motor monitoring system according to the second embodiment of the invention; and

FIG. 4 is a diagram illustrating a motor monitoring system according to the third embodiment of the invention.

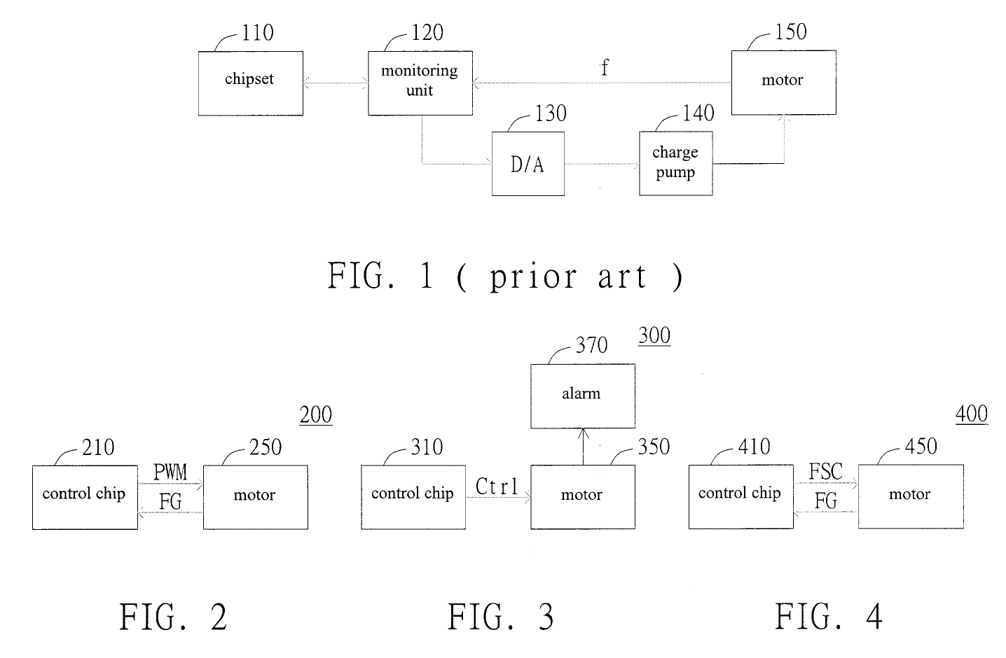

### DETAILED DESCRIPTION OF THE INVENTION

Please refer to FIG. 2, a diagram illustrating a motor monitoring system 200 according to the first embodiment of the invention. The motor 250 can automatically adjust the rotation speed of its own according to an inputted control signal, such as a waveform-controlled signal. And the waveform-controlled signal can be a pulse width modulation PWM control signal. The motor 250 operates according to the inputted control signal PWM. The frequency signal FG is further fed back to the control chip 210 so that the control chip 210 is informed of the rotational frequency. The control chip 210 is preferred to be a computer chipset or a monitoring chip. The control signal PWM from the control chip 210 is determined by the measured temperature and the fed-back frequency signal FG. As a result of the design, the configuration of the monitoring system is simplified, the R&D flow is shortened, and the cost of R&D and manufacturing are greatly reduced.

Please refer to FIG. 3, a diagram illustrating a motor monitoring system 300 according to the second embodiment of the invention. This monitoring system can be preferably applied in a notebook computer. A built-in FSC IC of the motor 300 functions to control the rotational speed. The built-in FSC IC can be further controlled by a chip set in the computer or another FSC IC. The motor monitoring system 300 includes a control chip 310 and a motor 350. The motor 350 is a frequency-controlled motor, which receives the frequency-controlled signal Ctrl and operates accordingly. The motor 350 of this embodiment is not required to feed the rotational frequency back to the control chip 310. The frequency-controlled signal Ctrl, which controls the rotational speed of the motors 350, for example, of the fan, is mainly determined by the measured ambient temperature. Hence, according to the second embodiment of the invention, the configuration of the monitoring system is simplified, the R&D flow is shortened, and the cost of R&D and manufacturing are greatly reduced.

The motor monitoring system 300 is an open-loop control system, which contributes to simplify the configuration. However, the recovery from the breakdown of an open-loop control system is a task. To prevent severe breakdown, the motor 350 can be further equipped with an alarm 370, which produces a warning while the motor operates in an unusual way, such as cease of rotation due to being locked or slow rotation down to a predetermined level. The alarm 370 can be, for example, an apparatus to give a warning sound or a flashing alert.

Please refer to FIG. 4, a diagram illustrating a motor monitoring system 400 according to the third embodiment of the invention. The motor monitor system 400 includes the control chip 410 and the motor 450. The motor 450 is a frequency-controlled motor, which receives the frequency-controlled signal FSC and operates accordingly. The motor 450 further feeds a frequency signal FG, with the data of the rotational frequency, back to the control chip 410. The frequency-controlled signal FSC, which controls the rotational speed of the motors 450, for example, of the fan, is determined by both the measured ambient temperature and the frequency signal FG.

The motor monitoring system according to the invention disclosed in the foregoing embodiments can simplify the configurations of the monitoring system and shorten R&D flow, and also reduce the cost of R&D and manufacturing.

In the above description, the motor monitoring system is stalled in a notebook computer, as an example. However, the invention is not limited thereto. On the contrary, the motor monitoring system can be installed in any kind of computers, or a control system of an industrial motor.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motor monitoring system, comprising:
a control chip for receiving a temperature reading and output a control signal based on the temperature reading; and
a motor which receives the control signal and automatically adjusts the motor's speed according to the control signal.

2. The motor monitoring system according to claim 1, wherein the motor is a frequency-controlled motor and the control signal is a frequency-controlled signal.

3. The motor monitoring system according to claim 1, wherein the motor is a waveform-controlled motor and the control signal is a waveform-controlled signal.

4. The motor monitoring system according to claim 3, wherein the motor further feeds a frequency signal indicating an operation frequency of the motor to the control chip, and then the control chip outputs the waveform-controlled signal according to the temperature reading and the frequency signal.

5. The motor monitoring system according to claim 1, wherein the motor further comprises an alarm, which produces a warning while the motor operates in an unusual way.

6. The motor monitoring system according to claim 5, wherein the alarm is an apparatus to give a warning sound.

7. The motor monitoring system according to claim 5, wherein the alarm is an apparatus to give a flashing alert.

8. The motor monitoring system according to claim 1, wherein the control chip is a chipset.

9. The motor monitoring system according to claim 1, wherein the control chip controls a rotational speed of the motor.

10. The motor monitoring system according to claim 1, wherein the motor monitoring system could be installed in a computer.

11. The motor monitoring system according to claim 1, wherein the motor monitoring system could be installed in a notebook computer.

12. The motor monitoring system according to claim 1, wherein the motor monitoring system could be used in a control system of an industrial motor.
